(19) United States
(12) Patent Application Publication
(10) Pub. No.: US 2024/0232543 A1
(43) Pub. Date: Jul. 11, 2024

(54) MULTIMEDIA STORY SERIES

(71) Applicants: Lia Horger, Bradenton, FL (US); Lee Horger, Bradenton, FL (US)

(72) Inventors: Lia Horger, Bradenton, FL (US); Lee Horger, Bradenton, FL (US)

(21) Appl. No.: 18/220,224

(22) Filed: Jul. 10, 2023

Related U.S. Application Data
(60) Provisional application No. 63/438,373, filed on Jan. 11, 2023.

(51) Int. Cl. G06F 40/40; G06F 16/48; H04L 51/02; H04L 67/306

(52) U.S. Cl. CPC G06F 40/40; G06F 16/48; H04L 51/02; H04L 67/306

(57) ABSTRACT

Described herein is an application for purchasing, receiving, viewing, and requesting changes for a digital story series that provides a user with a customizable experience and options for changing a story being delivered to the user that may be the same or different from a main story line being delivered to one or more other users. A user may request a customized portion, wherein the customization may be a simple change, such as to a single portion, or may be an extensive change that may alter the story line of one or more future portions. In another embodiment, a user may request a change that would be received by other users. Such changes may be to a reference such as a technical document, manual or guidebook, or textbook that originates from the author or is provided with permissions from the originator or copyright owner of the reference.

### BACKGROUND

Electronic applications for reading, listening to, or watching a story are popular in various formats, such as electronic books, audiobooks, and videos. However, these stories are usually a single story preset by an author (i.e. a static story) or have limited alternative endings that a user may select (such as choose-your-own-adventure books). There is increasing demand for customizable experiences in entertainment to reflect an individual's unique personality and preferences. However, creating truly personalized and engaging digital story series that can adapt to individual users' unique preferences and choices remains a challenge. Current methods for generating interactive narratives often result in disjointed stories and limited scope for personalization. Consequently, there is a need for a digital story series to evolve as an interactive collaboration between an author and a reader.

### SUMMARY

In one aspect, a method for generating a personalized interactive digital story series, includes receiving user input specifying story preferences and customization options; retrieving a plurality of story portions, each comprising text, images, audio, or video content, associated with the digital story series; receiving a user input to determine relevant story portions based on the specified preferences and customization options, wherein a user navigates between story portions, makes choices that influence the narrative, and customizes one or more aspects of the story portions; and presenting a customized sequence of story portions to the user in an interactive manner.

In another aspect, a method for purchasing a digital story series includes receiving a request from a user to purchase a digital story series; providing the user with a customizable experience and options for changing the story being delivered to the user; and delivering the digital story series to the user.

In yet another, a method for receiving a customized story portion includes receiving a request from a user to customize a story portion; determining the extent of customization requested by the user; incorporating the requested changes into the story portion; and delivering the customized story portion to the user.

In a further aspect, a method for requesting a customized story portion includes receiving a request from a user to request a customized story portion; receiving details of the customization requested by the user; communicating the customization request to an author; and delivering the customized story portion to the user based on the author's incorporation of the requested changes.

In another aspect, a method for requesting changes to a story portion that affect other users includes receiving a request from a user to request changes to a story portion; determining the changes requested by the user; communicating the changes to other users who have received or will receive the story portion; and delivering the changed story portion to the users.

In other aspects, a method for providing references with customizable changes includes providing a reference document to users; receiving requests for changes to the reference document; incorporating the requested changes into the reference document; and distributing the changed reference document to users who previously received the reference or will receive it in the future.

In another aspect, a method for cooperative multi-media story writing includes providing an application with an interactive menu for making selections; displaying the interactive menu in a sidebar, top, bottom, or constantly on the screen; allowing users to adjust various settings for the digital story, including volume, language preferences, speed settings, screen settings, and filters; enabling parental controls and limits on sounds; allowing users to set subtitles and language preferences; displaying the story portion in a selected language; and allowing users to save or change their method of payment.

In yet another aspect, a method for customizing aspects of digital media includes providing multiple interactive menus for different aspects of the digital media; allowing users to control music playback, customize screen navigation, submit reviews or feedback, and adjust screen settings through the respective menus.

In yet another aspect, a method for logging into an application includes requiring a user to log in to access application-related purchases and authorize new purchases; providing standard safeguards against fraudulent activity, such as passwords and two-factor authentication; allowing users to save preferred settings; allowing users to carry over settings from one device to another; and enabling users to resume their progress on a different device.

In yet another aspect, a method for purchasing individual story portions includes selling a digital story series to a user in story portions; offering individual story portions for purchase; varying the price of individual portions or providing them free of charge; and allowing users to select and download purchased story portions.

In yet another aspect, a method for requesting customization of story portions includes receiving a user's request for customization of a story portion; allowing simple or extensive changes, including correcting spelling, punctuation, grammar, changing character details, altering events, or modifying story settings; setting a price for replacement story portions or individualizing future story portions based on the changes; and delivering the customized story portions to users who have paid for them.

In yet another aspect, a method for editing and saving changes to story portions includes allowing users to edit story portions without author intervention; enabling users to save changes for future viewing; providing an option to revert to the original version; allowing users to undo selected changes; and indicating edited portions with font, coloring, or text size changes or visual tags.

In yet another aspect, a method for providing divergent main story lines includes offering multiple author-provided choices that affect the main story line; allowing users to select from the choices, and the application allows users to provide feedback on the digital story series, including submitting reviews, ratings, and comments on individual story portions or the overall experience.

In yet another aspect, an application is for purchasing, receiving, viewing, and requesting changes for a digital story series that provides a user with a customizable experience and options for changing a story being delivered to the user that may be the same or different from a main storyline being delivered to one or more other users. The application can provide a function where a user may make changes to a story portion for the personal use of the user. The application can provide a function where a user may request a customized story portion from the author, wherein the customization may be a simple change, such as to correct spelling, punctuation, or grammar of a single portion, or maybe an extensive change that may alter the storyline of one or more future portions, such as changing a love interest of a story character, introducing a new character, adding or deleting an event in the story, or changing the manner or time of death of a story character including a change such that the story character does not die.

In another aspect, a user may request a change that would be received by other users. For example, an author may provide a reference such as a technical document, manual or guidebook, or textbook that originates from the author or is provided with permissions from the originator or copyright owner of the reference. A user may request a change that the author incorporates into the reference so that any, some, or all users receive the changed reference. The changed reference may be distributed to any, some, or all users who previously received the reference, requests the changed reference, or will receive the reference at a later time. In another aspect, a method of cooperative multi-media story writing is provided.

Implementations of the above aspects can include one or more of the following. The application provides social sharing functionality, allowing users to share their customized story portions, recommendations, or comments on social media platforms or with other users of the application. The application includes a notification system that alerts users when new story portions are available, when their requested changes have been incorporated, or when other users have made changes that are relevant to their story experience. The application includes a bookmarking feature that allows users to mark specific points in the story for quick access or future reference. The application includes a search function that enables users to search for specific story portions, characters, events, or keywords within the digital story series. The application includes a collaboration feature that allows users to co-write or contribute to the development of the digital story series by submitting their own story ideas, character concepts, or plot suggestions. The application includes a gamification element that rewards users for their engagement, participation, or progress within the digital story series, such as unlocking achievements, earning virtual currency, or advancing in a virtual storyline. The application includes a recommendation system that suggests story portions, character arcs, or customization options based on user preferences, previous selections, or analysis of user behavior within the application. The application includes a community forum or discussion board where users can engage in discussions, share ideas, or seek assistance from other users or the author of the digital story series. The application allows users to access additional multimedia content related to the digital story series, such as concept art, behind-the-scenes videos, character profiles, or interactive maps, to enhance their immersive experience.

Advantages may include one or more of the following. The system combines customization, collaboration, interactivity, and community engagement to deliver an enhanced storytelling experience. It empowers users to shape the narrative, fosters creativity, and provides a platform for immersive and personalized storytelling. The system increases the contextual relevance of the narratives and leads to an optimal immersive user experience. The system provides personalized, contextually relevant, and deeply immersive interactive digital story series while allowing users to customize the story series based on their preferences and permitting the story to adapt based on user engagement feedback. The present system changes the landscape of storytelling by engaging audiences with immersion, personalization, and interactivity in their media consumption. This is done through unique customization opportunities that reflect individual readers' preferences, creating personalized experiences that engage audiences more deeply.

### BRIEF DESCRIPTION OF THE DRAWINGS

FIG. 1 shows an exemplary system architecture with server services to handle various operations efficiently and to improve computer performance.

FIG. 2 shows in more detail one embodiment of the backend architecture of the system.

FIG. 3 shows exemplary user category and subcategory databases in Personalized Interactive Digital Story Series.

FIG. 4 shows an exemplary method to generate a Personalized Interactive Digital Story.

FIG. 5 shows an exemplary throttle injection system to increase system performance and brings substantial advancements to API traffic management.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

As described herein, an “author” may indicate an originator of a digital story series, video series, technical document, manual, textbook, etc., and a “user” may indicate a recipient of a digital story series, video series, technical document, textbook, etc. An author may be an individual person, a group of people, a company, a proprietor of an automated story generator (e.g., through artificial intelligence), an account log-in, or the like, and is not limited to these examples. A user may be an individual person, a group of people, a company, an account log-in, or a device (e.g. a book, binder, movie theater, stage theater, computer, tablet, etc.), and is not limited to these examples. As described herein, a “main story” or “main story line” may refer to an original story, written work, audio work, video work, technical document, manual or guidebook, textbook, etc., provided by the author for any or all users who have not requested an individualized or changed story line.

Embodiments relate generally to an application that facilitates an author to distribute and sell and for a user to purchase, view, edit, and request changes to customizable digital media, such as an electronic book, audio story, or video series.

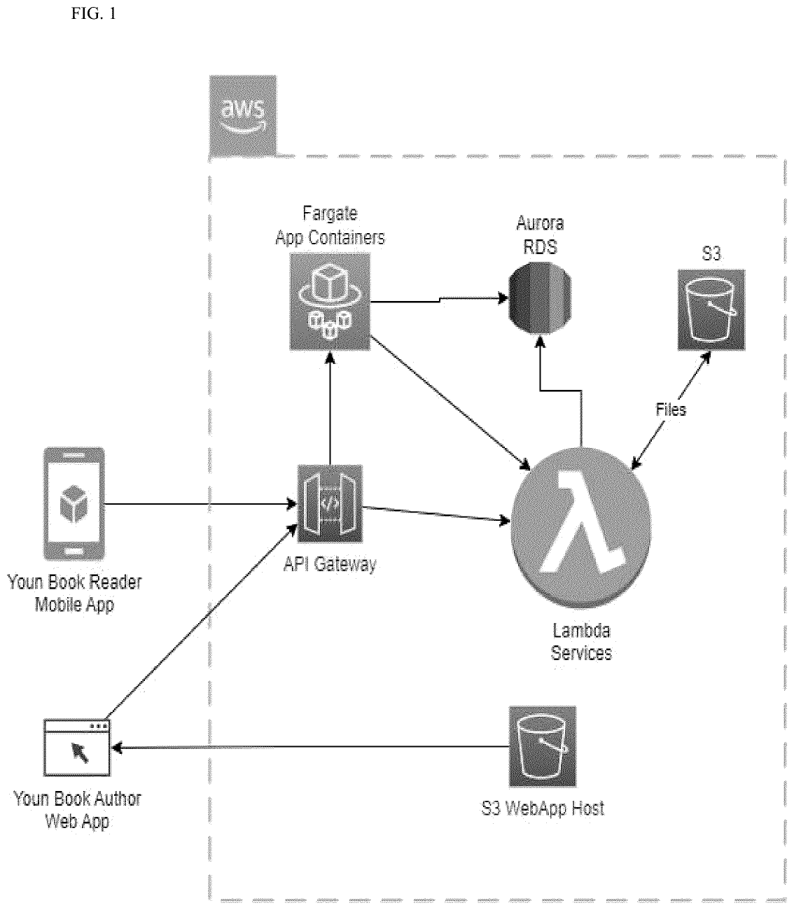

FIG. 1 shows an exemplary system architecture with server services to handle various operations efficiently and to improve computer performance. The system includes an API Gateway that acts as the entry point for data received from the reader mobile app or book author web app. The API gateway receives requests and forwards them to the appropriate Lambda services for processing. It also provides authentication, authorization, and request throttling capabilities.

The Lambda service receives data from the API Gateway, Fargate app containers, and files from S3 buckets, and executes serverless functions to process the received data. Lamba also performs operations such as data validation, customization, formatting, and transformation. It utilizes event-driven triggers to process data asynchronously.

The Fargate service runs containerized applications that require scalability and isolation. Processes and performs computations on data specific to the application's requirements. Fargate communicates with other services via APIs, such as retrieving data from Aurora RDS or S3 buckets which stores and manages files, such as digital story series, reference documents, or multimedia content. The bucket provides durable and scalable object storage for high availability and serves as a source for data input and output for various operations in the system. The bucket also triggers events to notify Lambda functions about file updates or additions.

The Aurora RDS acts as the relational database management system and stores structured data, such as user information, story portions, customization details, and system configurations. The RDS enables efficient querying and retrieval of data for personalized story delivery and integrates with Lambda functions to perform database operations, including inserts, updates, and retrieval.

In combination, the system as architected delivers computer performance increase as Lambda and Aurora work together to provide high-performance capabilities on demand. Lambda allows the system to run code without provisioning or managing servers. It automatically scales your functions in response to incoming requests, ensuring high-performance capabilities on demand. Lambda functions are triggered by events, such as API Gateway requests or S3 file updates. This event-driven architecture enables your functions to execute quickly and efficiently, as they only run when needed. Lambda can execute multiple function instances in parallel, allowing for concurrent processing of requests. This parallelism enhances performance by distributing the workload across multiple instances, enabling faster response times. Lambda automatically manages resources and allocates them as needed. It optimizes the underlying infrastructure to minimize cold start times and ensures efficient utilization of resources, leading to improved performance.

The system uses a High-Performance Database Engine in the form of Aurora which is designed for scalability and delivers fast query performance, making it suitable for demanding workloads. The Aurora database uses a distributed storage architecture and replicates data across multiple Availability Zones for enhanced durability and performance. It allows read replicas to offload read traffic, reducing the load on the primary database and improving overall performance. This database can automatically scale storage and compute resources to handle increasing workload demands as it dynamically adjusts resources based on usage patterns, ensuring high performance during peak times. The database incorporates an intelligent caching mechanism that accelerates read operations by caching frequently accessed data. This caching layer reduces latency and improves response times, especially for read-intensive workloads. The system runs Multi-AZ deployments that provide automatic failover capabilities and high availability. In the event of a primary database failure, the system seamlessly switches to a standby replica, minimizing downtime and maintaining performance. By combining Lambda's serverless computing and event-driven capabilities with Aurora's high-performance database engine and scaling capabilities, the system can achieve on-demand, high-performance processing and storage for the applications. The services work together seamlessly to handle varying workloads efficiently and deliver optimal performance to users.

The system flow generally follows these steps: Data is received from the reader mobile app or book author web app through the API Gateway. The API Gateway forwards the data to the respective Lambda functions for processing. Lambda functions perform operations on the received data, utilizing the capabilities of Fargate app containers and accessing files from S3 buckets. Processed data is stored or retrieved from Aurora RDS for further customization, story portion retrieval, or system configuration. Results or customized story portions are delivered back to the user through the appropriate channels, such as the mobile app or web app. This architecture provides a scalable, serverless, and decoupled system that increases computer processing speed/performance and efficiently handles data processing, storage, and delivery for the customizable digital story series.

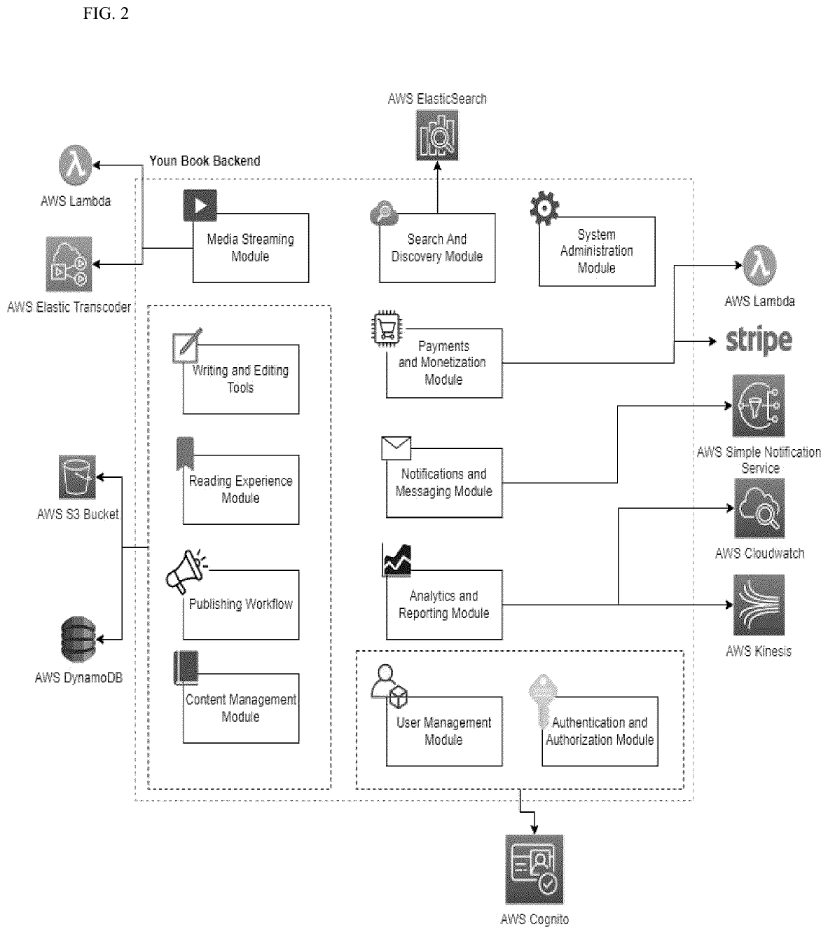

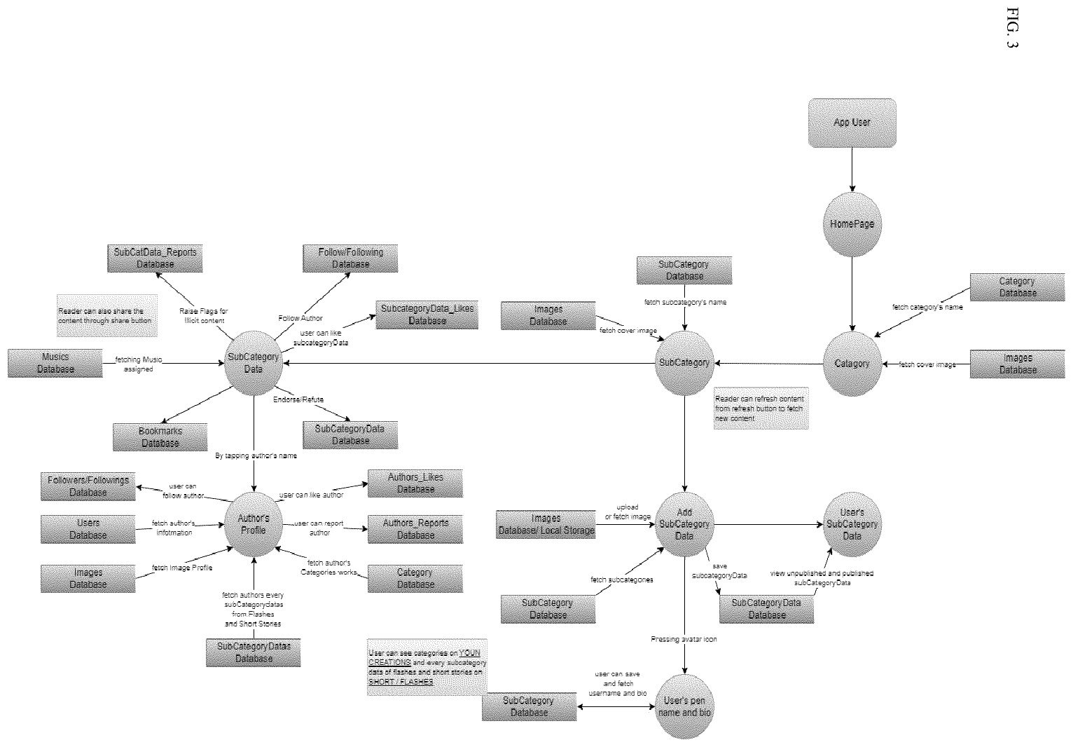

FIG. 2 shows in more detail one embodiment of the backend architecture of the system, while FIG. 3 shows exemplary user category and subcategory databases. Authentication and Authorization is done using Amazon Cognito for user authentication, identity management, and access control. The user management features enable the system to handle user accounts, including user registration, login, and managing user profile information. It provides a user directory that securely stores user data and allows for user authentication and authorization. Cognito can be used to manage user accounts, including registration, login, and user profile information. Amazon S3 is used to store and serve book files, audiobooks, and music. Amazon DynamoDB stores metadata about books, chapters, and associated media files, and it can track and store user-specific reading progress, bookmarks, and user preferences. Amazon S3: Store user-generated annotations, highlights, or notes.

The Writing and Editing Tools use Amazon S3 to store and version control the book drafts and revisions and AWS Lambda to trigger serverless functions for spell checking, grammar checking, or word count tracking.

The Publishing Workflow uses Amazon DynamoDB and manages book metadata, publication status, and editorial feedback. Amazon S3 is used to store cover images, book previews, or excerpts.

Media Streaming relies on Amazon S3 to store and serve audiobooks and music files while the Amazon Elastic Transcoder transcodes media files into suitable formats for streaming. Search and Discovery uses the Elasticsearch Service to index and search book metadata, enabling search and personalized recommendations.

Analytics and Reporting are done with Amazon CloudWatch which monitors system health, track API usage, and collect logs while Amazon Kinesis streams and processes user interaction data for analytics purposes.

Notifications and Messaging is done with Amazon Simple Notification Service (SNS) which sends notifications for book updates, comments, or messages. Amazon Simple Queue Service (SQS): Queue and process asynchronous messages between modules.

A payment vendor such as Stripe is used for secure payment processing while AWS Lambda triggers serverless functions for generating invoices or tracking revenue by integrating with payment gateways, generating invoices, and tracking revenue for monetization purposes. This enables a seamless payment experience for users and facilitates revenue management for the application.

The combination of these services provides a comprehensive infrastructure to support authentication, user management, content management, reading experience, writing and editing tools, publishing workflows, media streaming, search and discovery, analytics and reporting, notifications and messaging, as well as payment and monetization functionalities. This integrated system ensures secure and efficient operations while delivering a seamless user experience for both authors and readers.

The above architecture leverages various computer services to improve computer performance. The enhanced computer performance may include one or more of the following

Serverless Computing is used for performance enhancement. Executing serverless functions allows for automatic scaling and parallel execution means that the system can handle varying workloads efficiently, resulting in improved performance as resources are allocated dynamically based on demand.

The Event-Driven Architecture follows an event-driven approach, where Lambda functions are triggered by events such as API Gateway requests or file updates in S3. This event-driven model ensures that computations and processing occur only when necessary, reducing unnecessary resource usage and optimizing overall performance.

Scalability and Resource Optimization is achieved with services (for example Fargate, S3, and Aurora RDS, or available competitive services) which offer scalability and resource optimization capabilities. These services can scale up or down based on workload demands, ensuring that resources are allocated optimally and efficiently.

Distributed Storage and Replication: Services like S3 and Aurora RDS provide distributed storage and replication capabilities. This enhances performance by distributing data across multiple Availability Zones and enabling faster access to content. It also improves data durability and availability, further contributing to improved computer performance.

The architecture includes caching mechanisms, such as the intelligent caching in Aurora RDS and the option to cache frequently accessed data in Lambda functions. Caching improves response times and reduces the need for repeated computations or data retrieval, thereby enhancing performance.

Parallel Execution and Load Balancing also improves performance. The ability of Lambda functions and Fargate app containers to execute tasks in parallel enables efficient utilization of computing resources and load balancing. This helps distribute the workload across multiple instances, preventing bottlenecks and improving overall performance.

Monitoring and Optimization services provide monitoring capabilities, allowing for real-time monitoring of system health, resource usage, and performance metrics. This enables proactive identification of performance issues and optimization of the system to ensure optimal computer performance.

By utilizing these architectural elements and leveraging the scalability, event-driven nature, caching, distributed storage, and monitoring capabilities of compute services, the system is designed to enhance computer performance, handle varying workloads efficiently, and enable optimal resource allocation, reduces latency, and ensures a seamless and responsive experience for users.

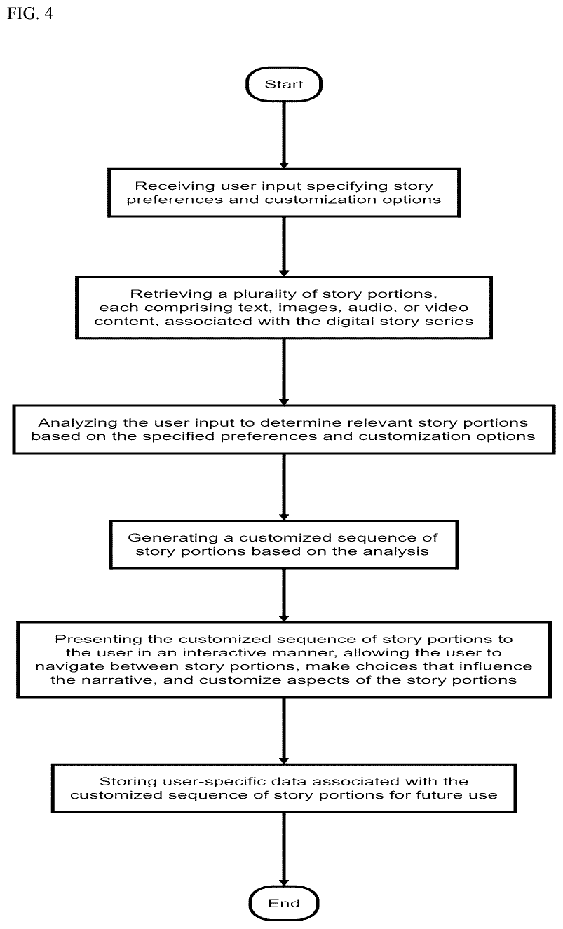

FIG. 4 shows an exemplary method to generate a Personalized Interactive Digital Story Series. The method for generating a personalized, interactive digital story series involves receiving user input regarding story preferences and customization options, retrieving relevant story portions based on this input, and presenting a customized sequence of these portions to the user interactively. Users can navigate the story, make choices that influence the narrative, and further customize story aspects. The method also stores user-specific data for future use. Additional features include receiving user feedback, allowing the user to specify preferences for genres, themes, character traits, plot twists, and more, applying machine learning algorithms for pattern recognition, offering various customization and interaction options, incorporating multimedia elements and real-time data, presenting the story on a variety of platforms and formats, and analyzing user engagement metrics to improve the story series. The invention can also allow for collaborative efforts between multiple authors or contributors, and offer features such as a chatbot or virtual assistant for enhanced user interaction.

The method includes phases that facilitate the personalization and customization of an interactive story by a user. Personalization and customization include selections of story preferences and customization options and interpretation of these preferences to determine relevant story portions. The story portions are elements of the digital story series, consisting of text, image, audio, or video content that can be combined and sequenced to create a unique and personalized story experience.

The method begins by receiving user input specifying story preferences and customization options. The user input may include a selection of themes, characters, settings, narrative styles, or other elements related to the story. These preferences and customization options allow the user to influence the aspects of the story series they are most interested in, resulting in a more engaging and meaningful experience.

The method proceeds by retrieving a plurality of story portions from a database or similar storage medium. These story portions are associated with and relevant to the digital story series. For example, a user may select a sci-fi theme, and relevant story portions fitting that theme, such as alien characters or futuristic settings, will be retrieved. The content contained in these story portions includes text, images, audio, or video content or a combination thereof.

After collecting the user's preferences and relevant story portions, the method involves an analytical process that interprets the user's input and aligns it with the applicable story portions. This process might employ algorithms or artificial intelligence methods to match the user's preferences efficiently with the most relevant and engaging story portions.

The next step involves the generation of a customized sequence of the retrieved story portions based on the analysis of the user's preferences. This sequence results in a unique composition of a story series, personalized to the user's given choices. This fusion of selected elements provides a bespoke digital story experience for the user.

The method finally involves presenting the customized sequence of story portions to the user in an interactive manner. This presentation allows the user to navigate through the tailored content, make choices that influence the narrative further, and customize aspects of the story portions throughout their experience. This interactive engagement boosts the immersive feel of the story and empowers the user to actively shape their narrative journey.

In the final stage, the user-specific data related to the user's preferences, choices made during the interactive narrative, and the final customized sequence of story portions get saved for future use. This data storage can enhance recall of the user's choices and preferences when they revisit or continue the story, allowing for a consistent and ongoing personalized story experience.

Incorporation of user feedback can be used to modify and enhance the storytelling experience. After displaying a customized sequence of story portions based on initial inputs from the user, the said platform implements a method to receive feedback regarding the user's reaction to the story. This feedback can include, but is not limited to, the user's enjoyment of particular storylines, the characters they are most drawn to, or any suggestions for upcoming sequences. This feature allows the users to be integrally involved in the evolution of the story, thereby creating a unique user-specific digital story series.

Not only does this method amplify user engagement, but it also ensures the story evolves according to unique user preferences, effectively creating a more immersive and personalized storytelling experience. This iterative process involves taking user feedback and incorporating it into subsequent iterations of the story series, enhancing the overall user experience. For instance, if a user expresses a particular interest in a character, upcoming sequences can be manipulated to highlight this character's arc. Similarly, if a user indicates a preference for a specific genre or storyline, future sequences can be optimized to reflect these inclinations.

This platform employs algorithms to process the feedback received, enabling the system to learn from the user's feedback and adapt the digital story series based on this data. The method can maintain a feedback loop with the user which allows narrative changes to reflect their preferences effectively. An important advantage of this embodiment is that it allows real-time adaptation based on the response and engagement of the reader, consequently promoting user retention and increasing user satisfaction with the digital story series platform. This method is highly beneficial for digital platforms aiming to offer dynamic and adaptive storytelling experiences that are tailored to fit individual user preferences.

The user can specify preferred genres, themes, or settings for the digital story series. In one embodiment, an interactive interface is provided to the users, which allows them to enter their preferences in terms of genres (such as romance, mystery, science fiction, etc.), themes (like adventure, crime, fantasy, etc.), or settings (for instance, historical era, future world, fantastical realm, etc.). Upon receiving the user input, the system processes the data and then generates a customized digital story series characterized by the selected genres, themes, or settings.

In one exemplary detail, the initial step taken by users in this method is the identification of their preferences related to genres, themes, or settings for the digital story series. The interactive interface presents multiple genres, themes, or settings categories for the users to choose from. Once the preferred genres, themes, or settings are selected, the system utilizes an artificial intelligence or algorithm-based tool to evaluate and process these preferences. This tool might operate via machine learning, natural language processing or a combination of both to amalgamate and interpret user preferences.

In the generation of the personalized digital story series, the method takes the processed user preferences into account and begins creation of the story series. AI may be used to construct narrative arcs, character profiles, plotlines, and dialogues reflecting the predetermined preferences to provide an innovative way of engaging users in a tailored narrative experience, providing them with a digital story series that is shaped according to their personal preferences in genres, themes, and settings. The embodiment of user choices enhances the engagement and brings a unique touch to the digital storytelling experience.

In embodiments, this invention can provide an immersive and personalized experience to users as they interact with the unfolding narrative of a digital story series. Users input their preferences and selections via an interface, where they can specify desired character traits, relationships, and/or roles within the story. Users can, for instance, choose to highlight bravery or intelligence in the lead character, determine the complex relationships between characters, and assign themselves or other characters specific roles within the narrative. Whether users want to focus on romance, mystery, adventure or something else, these user specifications add a distinct layer of personalization to the story, effectively shaping the narrative according to the user's desires.

Further to this, the method employs intelligent software algorithms that interpret these user inputs and adapt the story accordingly. The system can use machine learning or other AI technologies to predict the next steps of the story based on user input, providing a customized story progression that aligns with user preferences. Moreover, the technology incorporates user feedback over time, allowing the story to evolve with the user's changing tastes and preferences. In this way, the user's input is not just passive but constitutes an active and dynamic contributor to the direction of the story series, thereby offering a novel fusion of technology and storytelling that pushes the boundaries of interactive narrative experiences.

One embodiment focuses on allowing the user to specify certain preferred story elements such as plot twists, conflicts, or resolutions that they would like to see included in the digital story series. Upon the user input specifying these preferences, the system would then incorporate these elements into a dynamic and interactive digital story series. This unique story creation mechanism serves both as a creative outlet for users and provides an enhanced and personalized entertainment experience.

In the execution of the method, the user enters their preferred story elements via a user interface. For example, if a user prefers dramatic plot twists, they could specify this preference in the system, and the digital story series would incorporate such elements during its formulation. Similarly, if the user prefers a specific resolution, or a particular type of conflict, the system is capable of creating a story incorporating these wishes. The user thereby holds a significant influence over the direction of the narrative, which is optimized for an engaging user experience and boosts the user's connection to the resultant storyline.

The system is designed to accommodate a wide variety of narrative styles and genres and can adapt to users' dynamic preferences over time. A smart algorithm within the system could keep track of users' interactions and dynamic preferences, thereby providing more personalized and interactive content in the future. At its core, the invention creates an immersive storytelling experience that users can customize according to their personal storytelling preferences and emotional inclinations. This novel method disrupts traditional one-dimensional storytelling by bringing an innovative user-centered approach, promising a much richer, more engaging, and highly personalized entertainment experience.

In one embodiment, the method performs an analysis of user input data and matches it to the corresponding metadata associated with different portions of the story. The metadata may include various identified elements such as tags, keywords, or annotations, that are specifically integrated into the story segments for this purpose. The primary objective of this methodology is to provide a unique and personalized storytelling experience to each user, by allowing them to interactively specify preferences and customize their narrative path.

In an interactive storytelling system, the user inputs are provided in the form of specified preferences and customization options relating to the narrative sequence. The nature of these inputs can vary widely. For instance, a user may choose a preference for a particular genre, a specific storyline, select characters, narrative pace, key plot points, or any other element would shape the progression of the storyline. These inputs serve as guidelines for the system to take into consideration while initiating the interactive storytelling process.

One implementation involves the comparison of the user-specified preferences and customization options with the metadata incorporated into the story portions. The metadata is added in ways such as tags, keywords, annotations, which are carefully assigned to each story portion based on various aspects of the narrative content. When a user's preference aligns with the metadata of a particular story portion, the system delivers that segment to the user, thus personalizing their narrative experience. Correlatively, the system can smoothly intuit narratives even from complex or conflicting inputs, leading to seamless interactive storytelling that is sure to engage and captivate the user.

In one embodiment, a machine learning algorithms functions to construct a comprehensive profile on the user's preferences and behavioral patterns by leveraging comparisons, contrasts, and correlations. These user-specific profiles are then employed by the system to dynamically modify the narrative structure, pacing, plot elements, and other aspects of the digital story series in accordance with the derived user preferences. Ultimately, this offers the advantage of providing a more compelling, enriching, and individually tailored experience to users revealing a pattern of consistently positive impact on user engagement and satisfaction. Since machine learning algorithms continually learn and improve with increased usage and data input, the more a user interacts with the digital story series, the more tailored and enhanced their experience becomes. Additionally, this feature ensures that the system remains current and accurate in mapping and responding to users' evolving tastes and preferences. It successfully merges technology's potential with users' dynamic needs and expectations, revolutionizing how users engage and experience digital story series while offering a new horizon for personalization within the digital storytelling sphere.

One embodiment places users at the heart of their entertainment experience, stepping away from traditional linear storytelling and enabling a compelling interactive engagement. This can be done with a UI to modify essential character traits. For example, the user can adjust a character's physical appearance, transforming the color of their hair, clothes, height, weight, and other body features. Moreover, the personality traits of the characters such as their attitudes, behaviors, predispositions, and dialogues can also be easily manipulated by the user. This extends to the possibility of altering the abilities of characters, like their skills, knowledge, or power, thereby wholly transforming their role within the story. This results in a genuinely dynamic and individualized narrative, adding a unique flavor to the user's experience. It involves users directly in the creation process, not only resulting in a customizable digital story but also fostering a sense of ownership and deeply engaged empathy towards the characters. This technology has immense potential for application in gaming, animation, virtual reality, and augmented reality environments, where user interaction and engagement are essential. Thus, this invention embodies a significant leap in the future of interactive storytelling, paving the way for a new era in customized narrative experiences.

One implementation involves a functionality whereby pre-programmed alternative story branches, paths, or endings can be selected by the user, enabling individualized and immersive engagement with the digital content. This interactive digital narrative framework revolutionizes conventional linear storytelling, giving readers or viewers an element of active participation and decision-making power that controls narrative progression. The variety and diversity of the alternative storylines also substantially increase the replay value of the digital story series, enhancing user retention and satisfaction. Multiple interconnected elements can be used including, but not limited to, a user interface, custom story branches, and an Underlying decision-making algorithm responsible for facilitating and coordinating user choices. The user interface allows the player to interact with the digital narrative and to choose desired alternative branches or paths as per their personal preference, thereby crafting their custom narrative. The alternative story branches, paths, or endings are carefully developed and integrated within the circumscribed scope of the storyline, ensuring narrative cohesion and enhancing user immersion. Each user choice triggers the underlying decision-making algorithm, which coordinates these decisions and navigates the user towards their selected story path, resulting in a unique experiential narrative shaped by each user's specific choices.

In terms of utilization, users can access this digital storytelling application through a wide range of electronic devices such as smartphones, tablets, computers, or game consoles. We envision applications across various fields including, but not limited to, education, entertainment, and marketing. In education, the technology can promote active learning by providing students with a dynamic platform to explore different narrative outcomes based on their choices. In entertainment, users will delve into a unique, personalized narrative experience; while in marketing, businesses could harness this technology to provide consumers with interactive product experiences leading to potential increase in user engagement and loyalty. Thus, the invention offers not only a paradigm shift in digital storytelling but extends its implications to various practical domains, promising significant contributions to the evolution of user-centric digital experiences.

The method can spur interactive viewer engagement in a story-sharing domain such as online storytelling platforms, book clubs, video games, or the like. This invention presents a method of creating an interactive and immersive story experience through a customized sequence of story portions that incorporates user interactions. The method increases user retention, ensure user satisfaction, and to provide a unique experience of personalized engagement. The story portions can be derived from novels, articles, scripts, historical accounts, or other materials of narrative structure. The individual story portions are orchestrated in a continuous sequence, but the progression of the sequence is influenced by user activities.

In embodiments, the use of interactive prompts, choices, or puzzles for the user offers immersion to the users and make their experience more personalized, fascinating, and engaging. The interactive prompts can be questions related to the storyline that require the user to think critically and predict outcomes, furthering engagement. Choices may involve decision-making scenarios that alter the progress or outcome of the story based on the user's decision. Puzzles can be tasks or quizzes presented to the user, which test their understanding or recall ability of the story so far or provide additional interactive challenges that are necessary to move forward in the story. In this way, the storytelling experience is transformed into a participatory and interactive activity that diverges from the conventional linear model of narrative consumption.

This method is not just limited to individual user engagement, but it can also be implemented in a multi-user setting like group games, collaborative learning, or book club discussions. In this format, not only can the user individually interact with the story through prompts, choices or puzzles, but they may also discuss, debate, and collaborate with other users to deepen their comprehension and maximize engagement with the story. This interaction with other users can be made possible through chatrooms, message boards or other interactive platforms integrated with the main story-sharing interface. Thus, through synchronization of user activities, the effectiveness and user enjoyment in the progression of the customized sequence of story portions are significantly improved, transforming traditional story engagement into an interactive, immersive, and social experience.

The collected user-specific data extends to customization choices, providing the user with the ability to modify their interaction with the digital story series to suit their tastes accurately. This function characterizes the invention's capacity to adapt to each user uniquely, progressively evolving their story experience based on personal choices. An additional feature of this invention lies in its progress tracking capacity. As users engage with the digital story series, the system captures and records their progression intelligently within the series. This feature affords the users an effortless return to their last session or access to any other desired point within the entire series without having to manually remember or locate their position.

One embodiment provides a saved bookmarks feature, which improves user engagement significantly by allowing users to mark their favorite or significant sections of the digital story series for easy access later. The bookmarks offer facilitated navigation, enabling users to leap to saved parts directly, thereby enhancing the user's navigation experience within the digital story series. This bookmark feature is synchronized with the progress tracking feature for a seamless and convenient user interaction, particularly for returning users. Overall, the invention brings about an inventive solution that champions user preferences and enhances the user experience within a digital story series by personalizing the user's journey using user-specific data.

Such an immersive story experience could be, but is not limited to, a video game, an interactive book, or any digital program that unravels a narrative. The unique engagement of this system lies in its ability to remember user choices, preferences, and progress and store them as user-specific data on a cloud-based database. When a user engages with the immersive story experience on one device, their data (choices made, characters interacted with, levels completed, etc.) is immediately stored on the cloud-based database. The user can then switch to another platform or device and resume their story experience right from where they left off. This seamless transition between devices is facilitated by the immediate accessibility of the cloud database and its ability to sync in real-time. The application of this invention could range from a reader being able to continue an e-book story on a different device without losing their place, to a gamer maintaining game progress across console, PC, and mobile gaming platforms.

Additionally, the usage of user-specific data extends not merely to progress but to personalization of the story. The immersive story experience can be tailored to each individual user's preferences, choices, and actions stored in the cloud-based database. For example, the cloud-based system can generate tailored narrative sequences, create personalized gaming options, or suggest user-centric content. Consequently, the user is delivered a dynamic, ever-evolving story experience that adjusts according to their unique engagement. This use of cloud technology and user-specific data to personalize and maintain cross-platform continuity in immersive story experiences presents a significant advancement in user-centered design and story-based digital media consumption.

The method can leverages the creative insights of multiple authors or contributors to create a series of personalized interactive stories. Such stories would be designed in such a way that they can be customized by users, allowing for a distinctive narrative flow based on the individual user's decisions, choices or actions within the stories' virtual environments. By integrating multiple user inputs, this system would provide a novel, engaging and more immersive form of storytelling experience that goes beyond traditional linear narratives.

One implementation increases computer performance with a multi-dimensional database for categorizing, storing, and retrieving the narrative content created by different authors or contributors. This database not only serves as the repository of the narrative content but also as the basis for the generation of the personalized interactive stories. The system's algorithm processes the user's input and interacts with the database to dynamically configure and present the narrative content according to the user's preferences and interactive decisions. Through this, a personalized and novel experience is generated each time, enabling the user to experience a unique story plot every time they interact with the system.

Another embodiment employs artificial intelligence algorithms to streamline the coordination and consolidation of the inputs from the multiple authors or contributors. These algorithms would take into consideration various factors such as narrative structure, thematic consistency, and user preferences. They could also provide real-time feedback to the authors or contributors, potentially guiding the creative process by suggesting ideas or approaches based on user interactions and feedback. In essence, this system not only provides an innovative method for the production and consumption of interactive digital stories but also paves the way for a more collaborative and immersive storytelling experience.

Another embodiment enhances user engagement and enriches the story experience by providing a chatbot or virtual assistant within the said digital story series. The chatbot or virtual assistant can be programmed to embody various characters within the series, thereby offering a more integrated and immersive narrative experience. Essentially, the users are given the opportunity to interact with story characters, opening up a whole new dimension of engagement in storytelling. In order to augment the engagement level, this virtual assistant or chatbot is also capable of offering guidance and suggestions throughout the story. This feature gives the user an aiding tool while navigating through the story series—especially in more complex narratives—thus fostering a more enriched experience. Besides serving as guiding tools, these suggestions can also subtly challenge and stimulate the user's thoughts, thereby enhancing their understanding and appreciation of the story. The suggestions provided may also influence the trajectory of the narrative, establishing a dynamic platform where users can actively shape their own story experience. Furthermore, the chatbot or virtual assistant's natural language processing and machine learning capabilities enable it to learn and adapt to each user's preferences and interaction style. Over time, these chatbots or virtual assistants may develop a personalized interaction model for each user, thereby aligning the story narrative and user interaction more closely with the user's preferences. This invention thereby revolutionizes the concept of digital storytelling by providing an engaging, interactive, and highly personalized user experience. The unique amalgamation of technology with the art of storytelling marks a new chapter in the domain of interactive digital content and brings forth an innovative and immersive mode of experiencing narratives.

The method extends beyond traditional storytelling formats to create an immersive, dynamic, and personalized narrative experience, which is influenced in real-time by external factors like weather conditions, time of day, or location-based data. This innovative approach to constructing story narratives is a significant advancement in the field of digital storytelling and augmented reality applications. The method involves integration of real-time data into the selected portions of the story. For example, if the user is engaging with the story during a rainstorm in their local area, the narrative could adapt to this weather condition, incorporating elements of the rainstorm into the storyline. Similarly, a story experienced at night time could automatically adapt to incorporate the night setting into the narrative—maybe switch a day-time scene to night-time, or shift the narrative to a more mysterious mood. Similarly, location-based information could be used to adapt the story to include local landmarks or cultural nuances. This system is designed to gather context-specific real-time data from available sources and parse this into an appropriate format to be introduced into the story narrative. The result is an immersive and highly personalized experience that enhances not only the relevance of the story to the user's current environment, but also deepens their engagement and investment in the story as it unfolds.

To ensure seamless integration of real time data into the narrative, the method is designed to adaptively incorporate pertinent conditions into the narrative without disrupting the flow or causing inconsistencies. The system might include algorithms for intelligently suggesting possible narrative pathways based on the current data and smoothing over any disparities to create a cohesive narrative experience. The result is a profound, multilayered narrative that unfolds in harmony with the reader's environment, providing an immersive user experience that is both contextually aware and dynamically personalized. The adaptability of this system allows for potential in numerous applications, including but not limited to interactive novels, augmented reality games, immersive learning platforms, and enhanced user interfaces.

The instant curated storytelling approach takes into account user preferences or previous responses, delivering a narrative uniquely tailored for the individual. The apparatus for implementing this interactive storytelling method comprises a computing device with an interface suitable to visualize the content. The method is adaptive for various platforms, including but not limited to a mobile application, a web-based platform, a virtual reality environment, or an augmented reality interface.

The unique characteristic of the story portion delivery is its cross-platform application. In the case of a mobile application, the user interacts with the storytelling mechanism in a directly tactile and portable manner, enabling on-the-go interaction. The web-based platform enables access from diverse devices with internet connections, broadening the user base. Furthermore, by employing the method in a virtual reality or augmented reality environment, the inventive system propels storytelling into the next dimension of immersion by allowing the user to be intimately involved in the narrative, thereby creating an experiential and personalized storytelling adventure.

The adaptive method of presenting such a customized sequence of story portions is not limited to the modes stated earlier. It offers the potential to evolve and adapt to future developments and innovations in technology, thus underlining its dynamic and future-proof nature. This could include innovative forms of wearable technology or yet-to-be-invented interfaces. The interactive navigation through crafted narrative landscapes by the user's preference and choice symbolizes an innovation in delivering content, providing a compelling shift from traditional linear methods. The multi-platform ecosystem anchors the user to the heart of the narrative, marking a new frontier in the world of interactive storytelling.

One embodiment is a narrative or episodic content customization system that presents a sequence of story portions to a user in a personalized manner. It involves a unique algorithm that determines the user's preferences, tastes, reading speed, and comprehension ability, all done with the above computer performance enhancements. The method also considers the user's behavioral parameters such as the user's content consumption pattern, themes of interest, and preferred length of text content. Once these factors are determined, the system generates a customized sequence of story portions tailored to the user's distinct profile. The primary objective of this system is to improve the user's reading experience by offering them personalized, engaging content, thereby optimizing the usage of their content consumption time.

The method evolves beyond traditional content delivery systems that follow a fixed sequential pattern. Users often find such systems lack appeal due to their repetitive nature and their inability to adapt to the user's changing preferences over time. The present system, however, breaks down the traditional continuity of a narrative or episodic content to offer versatility. The same base content is modified and ordered uniquely for each user, based on their input/interaction with the system, keeping the content fresh and relevant. Moreover, it presents the sequence either as a continuous narrative or as episodic content—the method thereby ensuring flexibility, variety, and rich user engagement.

One embodiment employs machine learning techniques to track the user's interactions with the system constantly, to learn about and adapt to the user's evolving preferences. This adaptive learning property makes the system dynamic and responsive, facilitating a unique, individualized experience for each user. The machine learning feature also enables the system to identify patterns not explicitly stated by the user, providing recommendations that the user might find appealing, thereby enriching the user's experience over time. This innovative combination of preference-based customization, episodic or continuous narrative sequence presentation, and machine learning attributes this patent with a high degree of novelty and application potential.

Yet other aspects employ user engagement metrics such as amount of time spent on each section of the story, choices made by the user, as well as feedback provided by the user to enhance the personalization and overall quality of the digital story series. This enhancement process is achieved by continuously monitoring and analyzing user engagement metrics and dynamically adapting the content, sequence, and/or other elements of the digital story series.

In one implementation, an initial story series is prepared and delivered to a user in digital form. This digital form can be, for example, an e-book, a video, or a game. The user's engagement with the story series is then monitored, and various metrics are recorded, which can include, for example, the time spent on each portion of the story, the choices made by the user during the story, and any feedback provided either implicitly (such as through reactions or behavior) or explicitly (such as through ratings or comments). These metrics are then analyzed to understand user preferences, engagement levels, and any potential areas for improvement in the story series. Based on the analysis, several changes can be made to the digital story series. For instance, the order or content of the story can be adjusted, the level of detail or pace can be changed, or new features or enhancements can be added, all with the aim of improving user engagement, enjoyment, and retention of the story series. By allowing for a dynamic, personalized, and quality-driven approach to digital storytelling, the method of the present invention allows digital story series to constantly evolve and improve, optimizing the user experience and maximizing the value derived from each story.

The application may have an interactive menu for making selections. The interactive menu may be located on a sidebar, at the top of a screen or page, or may be at the bottom of the screen or page. The interactive menu may be buttons, icons, or tabs. The interactive menu may be hidden except when activated, such as by activating a button or icon or by hovering a cursor near the top, bottom, or side of the screen or page. Alternatively, the interactive menu may be constantly displayed on the screen or page. The user may be given the option to choose whether the interactive menu remains hidden except when activated or to keep it constantly displayed.

The interactive menu may include a button, icon, or tab for adjusting the settings for the digital story. The settings may include volume adjustment, language preferences for the text of the interactive menu, speed settings such as the rate of automatic screen scrolling or page turning, the rate of audio playback, or screen refresh rate. The settings may allow the user to adjust the brightness of the screen, contrast of the display, or to change the color tones. Other digital filters may be applied, such as changing color schemes to/from full color spectrums to black-and-white, sepia, or other common color filters. Settings may allow a user to filter out background noises from the audio so that only selected features are played, such as only playing a narrator or a character's voice. The settings may allow the user to set parental controls or to place limits on sounds such as limiting loud volume, high-pitches, or low-tones. The settings may allow a user to turn on/off subtitles or change the language preferences of subtitles or audio. The settings may allow an entire story portion to be displayed in a language selected by the user. The different languages may be pre-programmed by an author or may be machine-translated. The settings may allow a user to save or change a previously saved method of payment (e.g. to be used for application-related purchases).

The application may include more than one interactive menu for making selections. For example, a menu in one location may be for controlling music playback while a menu in another location may be for customizing other aspects of the digital media such as screen navigation, submitting reviews or other feedback, or adjusting the screen settings.

The application includes where the user logs into the application. The log-in portion may include standard safeguards against fraudulent activity such as requiring a password, using two-factor authentication, or other known safeguards. By logging into the application, a user can have access to previously obtained application-related purchases, can authorize new purchases, and/or can send requests for changes to the author. By logging into the application, a user can save preferred settings. When a user has the application on more than one device, then logging into the application can allow a user to carry over settings from one device to another and/or may allow a user to pick up on another device at the same point in the story as was left off on a different device.

In one aspect, an application is used for purchasing, receiving, viewing, and requesting changes for a digital story series that provides a user with a customizable experience and options for changing a story being delivered to the user that may be the same or different from a main story line being delivered to one or more other users. The digital story series may be sold to a user in story portions, for example as parts of a story book in a manner similar to book chapters or as a short video that is part of an ongoing story line in a manner similar to episodes of a television series. The price of individual portions may vary or may be the same for each portion. The price may be free of charge.

The application may allow a user to request a customized portion, wherein the customization may be a simple change, such as to correct spelling, punctuation, or grammar of a single portion, or may be an extensive change that may alter the story line of one or more future portions, such as changing a love interest of a story character, introducing a new character, adding or deleting an event in the story, or changing the manner or time of death of a story character including a change such that the story character does not die. A user may request to alter an event that occurs in the past of a story line, and may include changing descriptions of events that occurred in real history that are used as part of a story line.

A user may choose to change the setting for the story such as events occurring in a different city or country, or to a different planet, galaxy or other location in the known universe or in an alternate universe. The setting may possibly change from a rural to an urban setting or vice versa. The time period of the story may be changed, such as to a specific historical time period, to a current time period, or even to a future time period. A user may choose a different description for the appearance of a story character such as a change of physical attributes such as race, coloring (e.g. hair, eyes, skin, etc.), gender, cultural identity, height, weight, health, physical fitness, personality, social status, etc. and may even change the creature type of a story character, such as human, merfolk, spirit, animal, plant, or other types of being including types of beings previously described in literature or science and types of beings that are newly imagined (i.e. fantastical or fictional).

The application may be used to facilitate payment and downloading content for one or more story portions and for one or more individualized story portions. The author may set a price for a replacement of the individual story portion and, when the change is an extensive change, for individualizing future story portion(s) that maintain the changed story line. The price may be free of charge, can be the same for all types of changes, or may vary for any reason decided by the author, such as being dependent on the extent of changes requested. The price may be negotiable, or the user may be given the option of simply paying the price or not (i.e. non-negotiable).

After receiving payment for a replacement story portion, the author will send the user a replacement of the individual story portion having the requested changes so that the replacement individual story portion can be downloaded through the application. When the author sends the next story portion, users who have not paid for an individual story portion that alters the main story line will receive a copy of the story portion following the main story line whereas users who have paid for an individual story portion that alters the main story line will receive an individualized story line incorporating the previously agreed upon customization.

The application may allow a user to edit or make changes to a story portion without requesting the change from the author and to save these changes for future viewing. The application may allow a user to return the story portion to the version as it was originally received. The application may allow a user to undo selected changes. Any changes made by a user may be displayed continuously with the original story portion or may show that it has been edited such as by changing the font, coloring, or text size, or by adding an icon or other tag to show that the story portion has been changed.

An author may choose to provide a divergent main story line (i.e. multiple main story lines) to be downloaded using the application, where a user is given the ability to select from author-provided choices that affect the main story line. In such a case, the main story line may have more than one main story line being sent to different users based on each user's selection from the author-provided choices. Divergent story lines may have the same price, or different prices, for each choice. The price may be free.

As with a single main story line, a user may use the application to request a customized portion for a divergent main story line. Any change, such as any of the aforementioned changes to a single main story line, may be requested using the application for a divergent main story line.

Alternatively, a user may use the application to request to return to the point of divergence and select a different author-provided choice. As with a request for a customized portion of a single main story line, the author may set a price for a replacement of the individual story portion (i.e. of the divergent main story line) and, when the change is an extensive change, for individualizing future story portion(s) that maintain the changed story line. The price may be free of charge, can be the same for all types of changes, or may vary for any reason decided by the author, such as being dependent on the extent of changes requested. The price may be negotiable, or the user may be given the option of simply paying the price or not (i.e. non-negotiable).

After receiving payment for a replacement story portion of the divergent main story line, the author will use the application to send the user a replacement of the individual story portion having the requested changes. When the author sends the next story portion, users who have not paid for an individual story portion that alters the divergent main story line will receive a copy of the story portion following their selected option of the divergent main story line to be downloaded and viewed using the application whereas users who have paid for an individual story portion that alters the main story line will receive an individualized divergent story line incorporating the previously agreed upon customization to be downloaded and viewed using the application.

The author may use the application to provide one or more story portions that converge divergent main story lines where the events resulting from more than one divergent main story line come together such that the more than one divergent main story lines follow the same main story line. As with a single main story line or a divergent main story line, a user may use the application to request a customized portion for a convergent main story line. Any change, such as any of the aforementioned changes to a single main story line, may be requested via the application for a convergent main story line. Alternatively, a user may use the application to request to return to the point of divergence from the user's selected divergent story line (i.e. the point of divergence before the point of convergence) and select a different author-provided choice. As with a request for a customized portion of a single main story line, the author may set a price using the application for a replacement of the individual story portion (i.e. of the convergent main story line) and, when the change is an extensive change, for individualizing future story portion(s) that maintain the changed story line. The price may be free of charge, can be the same for all types of changes, or may vary for any reason decided by the author, such as being dependent on the extent of changes requested. The price may be negotiable, or the user may be given the option of simply paying the price or not (i.e. non-negotiable).

After receiving payment for a replacement story portion of the convergent main story line, the author will use the application to send the user a replacement of the individual story portion having the requested changes. When the author sends the next story portion, users who have not paid for an individual story portion that alters the convergent main story line will receive a copy of the story portion following the author-selected convergent main story line whereas users who have paid for an individual story portion that alters the main story line will receive an individualized convergent story line incorporating the previously agreed upon customization. The application will allow the user to download and view the received story portion.

All story portions received by a user may be saved in the application. The application may allow the user to choose which of the received story lines to display. Sequential story lines may automatically be added to the displayed story line in the application to continue the user-selected story line. For example, if the user requested a change to a main story line that alters future story portions and paid for the changes to be perpetuated, then the altered story line including the future story portions that depend on the change(s) may be the default displayed story of the application. Alternatively, the user may use the application to choose to display the unaltered main story line. In such a case, the default story displayed by the application may include only story portions received that follow the main story line. However, if a user had followed one divergent story line and then chosen to return to the point of divergence and selected a different divergent story line, more than one story line may be available in the application that spans more than one story portion. When more than one story line is available to a user that spans more than one story portion, then application can allow the user to choose which story line to display and by default the sequential story portion(s) affiliated with the user's selection will also be displayed. The application may allow a user to choose to display a different story portion (such as a story portion that follows a different divergence in the main story line), in which case the sequential story portion(s) affiliated with the user's different selection will be displayed.

Alternatively, the application may give the user the option to choose each story portion from the story portions available to the user such that changed story portions and unchanged story portions may be arranged in a mix-and-match fashion. By enabling this option, the user may more fully customize the story.

The application may be used to provide one or more audio features that may be played in cooperation with a digital story series or may be a separate audio track. The audio features may include a single preset track or may have one or more options of different tracks that may be selected such as different voice qualities for a character or different background sounds that set the mood of the story. Some or all the audio features may be pre-recorded by instruments, live actors or voice actors, or other acoustic sound generating objects or equipment. Alternatively, some or all the audio features may be generated digitally from a synthesizer or other similar electronic sound generator. One or more audio features may include a combination of digital, mechanical, and/or biological sound sources.

The application can provide the one or more audio features to automatically play, to have a built-in play feature, or to be played on demand by user input. For example, the application may provide one or more audio features to play in sync with video or during an audio book narration. The application may play one or more audio features when a user opens a file, turns a page, or reaches a particular point in a story. The application may allow a user to turn on or off one or more audio features, such as by providing a setting that can be activated to turn on/off background or mood setting music, background sounds, play a theme song, turn on/off audio narration, etc. A user may be provided with an on-screen indicator in the application that one or more audio features are available to be activated at various points throughout the story, such as book words being a different color or by an icon appearing on a page such as in a margin, in the middle of text, or at the start or end of paragraphs.

One or more audio features may include vocalized dialogue of story characters to be played via the application. The vocalized dialogue (i.e. a voice of a story character) may be pre-recorded by live on-screen actors or voice actors or can be digitally synthesized. The voice of a story character may be a voice that is pre-set by the author. Alternatively, the application can be used to provide a user with more than one option for the voice of a story character. When a user is provided with more than one option for the voice of a story character, the application for playing the digital story series may save the user's selection so that the same voice of a story character is used at other points in the story that includes vocalized dialogue of the same story character. The application may include an option for the user to change the voice of a story character from the selected voice to a different voice.

The author may use the application to provide one or more additional features to supplement the main story line, a revised story line, a divergent story line, or a convergent story line. Examples of the one or more additional features may be a video, a photograph, a digital picture, an icon or other graphic element. Any one or more of the one or more additional features may be words and may be in written and/or audio format. The one or more additional features may be a message from the author to the users. The one or more additional features may be a supplement to the story such as a thought bubble, an aside (i.e. wherein the dialogue of a story character is addressed to the audience or reader, which is the user), a reminder of a prior event in the story, or may provide insight into a character's feelings or thoughts. The additional features to be provided using the application are not limited to these examples, and one or more additional features may be provided separately or in combination.

The application may provide the one or more additional features to automatically play or be shown on screen, to have a built-in play or display feature, or to be played or displayed on demand by user input. For example, the application may play or display one or more additional features when a user opens a file, turns a page, or reaches a particular point in a story. A user may be provided with an on-screen indicator that one or more additional features are available to be activated at various points throughout the story, such as book words being a different color or by an icon appearing on a page such as in a margin, in the middle of text, or at the start or end of paragraphs.

In another embodiment, the application may allow a user to request a change that would be received by other users. For example, an author may provide a reference such as a technical document, manual or guidebook, or textbook that originates from the author or is provided with permissions from the originator or copyright owner of the reference. In such example, the application may allow a user may request a change that the author incorporates into the reference so that any, some, or all users receive the changed reference. The changed reference may be distributed via the application to any, some, or all users who previously received the reference, requests the changed reference, or will receive the reference at a later time. The change to the reference may be incorporated in any format, such as an icon indicating additional comments or instructions are available, a footnote, a note in a page margin, a digital “sticky note”, a link to a website, a change in the color of text, a pop-up message, etc. The change may be in written form, as an audio recording, as a video recording, or any combination of these. The change may replace a portion of the original reference, be inserted into the original reference, be a deletion from an original reference, or be displayed as an addendum, appendix, or supplement to an original reference.

In another embodiment, the application may allow a user to register or request permissions to become a recognized author. A user who has become an author may receive an update or alternative to the application that allows the user to send, sell, or otherwise distribute original or edited work, such as one or more short stories or one or more story portions.

The application may include shared media other than stories. For example, the application may allow users to post topics of interest to a news feed and to express their opinions regarding the topic. The application may allow users to vote on a post as being “real” or “fake” (i.e. according to the user) and may compile and display statistics regarding the number and/or percentage of users who have voted for the post as being “real” or “fake”. The application may allow users to choose to follow a news feed (i.e. the communications pertaining to the news feed becomes prioritized for viewing), remove the news feed from being prioritized, and/or post a response and to a news feed. The application may limit the response to text only or may allow links to website or other copied information to support the opinion expressed by a user. The application may allow a user to search for other news feeds relevant to a desired topic and/or news feeds may be arranged into categories. The application may allow an author to remove a news feed that is undesired, such as a news feed that could be harmful to others. The application may allow an author or administrator of the application to block a particular user or author from posting news feeds and/or from posting responses to news feeds.

In another aspect, a method of cooperatively writing a multi-media story is provided. Authors and users use an application for submitting, selling, distributing, purchasing, receiving, viewing, and requesting changes for a digital story series that provides a user with a customizable experience and options for changing a story being delivered to the user that may be the same or different from a main story line being delivered to one or more other users. The digital story series may be sold to a user in story portions, for example as parts of a story book in a manner similar to book chapters or as a short video that is part of an ongoing story line in a manner similar to episodes of a television series. The price of individual portions may vary or may be the same for each portion. The price may be free of charge.

A user may request a customized portion from the author, wherein the customization may be a simple change, such as to correct spelling, punctuation, or grammar of a single portion, or may be an extensive change that may alter the story line of one or more future portions, such as changing a love interest of a story character, introducing a new character, adding or deleting an event in the story, or changing the manner or time of death of a story character including a change such that the story character does not die. A user may request to alter an event that occurs in the past of a story line, and may include changing descriptions of events that occurred in real history that are used as part of a story line. A user may choose to change the setting for the story such as events occurring in a different city or country, or to a different planet, galaxy or other location in the known universe or in an alternate universe. The setting may possibly change from a rural to an urban setting or vice versa. The time period of the story may be changed, such as to a specific historical time period, to a current time period, or even to a future time period. A user may choose a different description for the appearance of a story character such as a change of physical attributes such as race, coloring (e.g. hair, eyes, skin, etc.), gender, cultural identity, height, weight, health, physical fitness, personality, social status, etc. and may even change the creature type of a story character, such as human, merfolk, spirit, animal, plant, or other types of being including types of beings previously described in literature or science and types of beings that are newly imagined (i.e. fantastical or fictional).

An author may use an application to facilitate payment and for distributing content for one or more story portions and for one or more individualized story portions. The author may set a price for a replacement of the individual story portion and, when the change is an extensive change, for individualizing future story portion(s) that maintain the changed story line. The price may be free of charge, can be the same for all types of changes, or may vary for any reason decided by the author, such as being dependent on the extent of changes requested. The price may be negotiable, or the user may be given the option of simply paying the price or not (i.e. non-negotiable).

After receiving payment for a replacement story portion, the author will send the user a replacement of the individual story portion having the requested changes so that the replacement individual story portion can be downloaded through the application. When the author sends the next story portion, users who have not paid for an individual story portion that alters the main story line will receive a copy of the story portion following the main story line whereas users who have paid for an individual story portion that alters the main story line will receive an individualized story line incorporating the previously agreed upon customization.

An author may choose to provide a divergent main story line (i.e. multiple main story lines) to be downloaded using the application, where a user is given the ability to select from author-provided choices that affect the main story line. In such a case, the main story line may have more than one main story line being sent to different users based on each user's selection from the author-provided choices. Divergent story lines may have the same price, or different prices, for each choice. The price may be free.

As with a single main story line, a user may use an application to request a customized portion for a divergent main story line. Any change, such as any of the aforementioned changes to a single main story line, may be requested for a divergent main story line. Alternatively, a user may use the application to request to return to the point of divergence and select a different author-provided choice. As with a request for a customized portion of a single main story line, the author may set a price for a replacement of the individual story portion (i.e. of the divergent main story line) and, when the change is an extensive change, for individualizing future story portion(s) that maintain the changed story line. The price may be free of charge, can be the same for all types of changes, or may vary for any reason decided by the author, such as being dependent on the extent of changes requested. The price may be negotiable, or the user may be given the option of simply paying the price or not (i.e. non-negotiable).

After receiving payment for a replacement story portion of the divergent main story line, the author will use the application to send the user a replacement of the individual story portion having the requested changes. When the author sends the next story portion, users who have not paid for an individual story portion that alters the divergent main story line will receive a copy of the story portion following their selected option of the divergent main story line to be downloaded and viewed using the application whereas users who have paid for an individual story portion that alters the main story line will receive an individualized divergent story line incorporating the previously agreed upon customization to be downloaded and viewed using the application.

The author may choose to provide one or more story portions that converge divergent main story lines where the events resulting from more than one divergent main story line come together such that the more than one divergent main story lines follow the same main story line. As with a single main story line or a divergent main story line, a user may use the application to request a customized portion for a convergent main story line. Any change, such as any of the aforementioned changes to a single main story line, may be requested via the application for a convergent main story line. Alternatively, a user may use the application to request to return to the point of divergence from the user's selected divergent story line (i.e. the point of divergence before the point of convergence) and select a different author-provided choice. As with a request for a customized portion of a single main story line, the author may set a price using the application for a replacement of the individual story portion (i.e. of the convergent main story line) and, when the change is an extensive change, for individualizing future story portion(s) that maintain the changed story line. The price may be free of charge, can be the same for all types of changes, or may vary for any reason decided by the author, such as being dependent on the extent of changes requested. The price may be negotiable, or the user may be given the option of simply paying the price or not (i.e. non-negotiable).

After receiving payment for a replacement story portion of the convergent main story line, the author will use the application to send the user a replacement of the individual story portion having the requested changes. When the author sends the next story portion, users who have not paid for an individual story portion that alters the convergent main story line will receive a copy of the story portion following the author-selected convergent main story line whereas users who have paid for an individual story portion that alters the main story line will receive an individualized convergent story line incorporating the previously agreed upon customization. The application will allow the user to download and view the received story portion.

All story portions received by a user may be saved in the application. The application may allow the user to choose which of the received story lines to display. Sequential story lines may automatically be added to the displayed story line in the application to continue the user-selected story line. For example, if the user requested a change to a main story line that alters future story portions and paid for the changes to be perpetuated, then the altered story line including the future story portions that depend on the change(s) may be the default displayed story of the application. Alternatively, the user may use the application to choose to display the unaltered main story line. In such a case, the default story displayed by the application may include only story portions received that follow the main story line. However, if a user had followed one divergent story line and then chosen to return to the point of divergence and selected a different divergent story line, more than one story line may be available in the application that spans more than one story portion. When more than one story line is available to a user that spans more than one story portion, then application can allow the user to choose which story line to display and by default the sequential story portion(s) affiliated with the user's selection will also be displayed. The application may allow auser to choose to display a different story portion (such as a story portion that follows a different divergence in the main story line), in which case the sequential story portion(s) affiliated with the user's different selection will be displayed.

Alternatively, the application may give the user the option to choose each story portion from the story portions available to the user such that changed story portions and unchanged story portions may be arranged in a mix-and-match fashion. By enabling this option, the user may more fully customize the story.

In another embodiment, the author may use to application to allow a user to request a change that would be received by other users. For example, an author may provide a reference such as a technical document, manual or guidebook, or textbook that originates from the author or is provided with permissions from the originator or copyright owner of the reference. In such example, the application may allow a user may request a change that the author incorporates into the reference so that any, some, or all users receive the changed reference. The changed reference may be distributed via the application to any, some, or all users who previously received the reference, requests the changed reference, or will receive the reference at a later time. The change to the reference may be incorporated in any format, such as an icon indicating additional comments or instructions are available, a footnote, a note in a page margin, a digital “sticky note”, a link to a website, a change in the color of text, a pop-up message, etc. The change may be in written form, as an audio recording, as a video recording, or any combination of these. The change may replace a portion of the original reference, be inserted into the original reference, be a deletion from an original reference, or be displayed as an addendum, appendix, or supplement to an original reference.

In another embodiment, an author may use the application to allow a user to register or request permissions to become a recognized author. A user who has become an author may receive an update or alternative to the application that allows the user to send, sell, or otherwise distribute original or edited work, such as one or more short stories or one or more story portions. An author may use the application to allow a user to register or request permission to become a recognized artist contributing non-written work to be distributed by the application. For example, a user may request permission to submit music, vocal tracks, video, etc. that other users may download or view/listen or purchase for downloading or viewing/listening.

The author may invite multiple users to attend a special event. The special event may occur virtually (i.e. via internet connection) or may be an in-person event where people meet at a physical location such as a brick-and-mortar store, eating establishment, rental venue, or a privately owned location. The special event may require a user to purchase access to the event such as by ticket sale or by requiring conditions to be met for admission, such as a donation, purchase of a special application or log-in, or by simply showing up at the event location. The special event may allow the author to host a collaborative writing session, host a book signing event, host a question-and-answer session (i.e. a “Q & A”), or host a promotional event. The author may reserve all rights to material developed during a collaborative writing session or may choose to share intellectual rights to the results of collaboration.

Advantages of the above system may include one or more of the following:

Customizable User Experience: The method provides users with a customizable experience and options to change the story being delivered to them. This level of customization allows users to tailor the story to their preferences, resulting in a more engaging and personalized experience.

Flexibility in Story Portion Customization: Users can request customized story portions, ranging from simple changes like correcting spelling or grammar to extensive changes that alter the storyline. This flexibility empowers users to actively participate in shaping the narrative and makes the storytelling experience more immersive.

Collaborative Story Writing: The method facilitates cooperative multi-media story writing, allowing users to contribute their own story ideas, character concepts, or plot suggestions. This collaborative approach fosters creativity, engagement, and a sense of ownership among users.

Enhanced Interactivity and Multimedia Integration: The application includes interactive menus, adjustable settings, parental controls, and language preferences, enabling users to customize various aspects of the digital media. Additionally, the integration of multimedia content such as concept art, behind-the-scenes videos, or interactive maps enhances the immersive experience for users.

Efficient Content Management: With the use of Amazon S3, the method efficiently manages and serves various content types, including digital story series, reference documents, multimedia files, and user-generated annotations. This ensures easy access, organization, and retrieval of content for users.

Seamless Cross-Device Experience: The method allows users to log in and access their personalized settings, progress, and purchases across multiple devices. This seamless cross-device experience ensures continuity and convenience for users, enabling them to continue their story experience from where they left off.

Dynamic Story Evolution: By allowing users to request changes to story portions and incorporating those changes into future portions, the method ensures a dynamic and evolving story. This feature keeps users engaged and excited about upcoming story developments.

Community Engagement and Social Sharing: The application provides social sharing functionality, allowing users to share their customized story portions, recommendations, or comments on social media platforms or with other users. This fosters a sense of community, encourages user interaction, and enhances the overall user experience.

Data-Driven Recommendations: The method includes a recommendation system that suggests story portions, character arcs, or customization options based on user preferences, previous selections, and analysis of user behavior. This data-driven approach enhances user engagement and helps users discover content aligned with their interests.

Monetization and Revenue Opportunities: The method offers monetization options by selling digital story series, individual story portions, or customization features. This provides revenue opportunities for authors, publishers, and content creators, while offering users the flexibility to choose the content and customization options they desire.

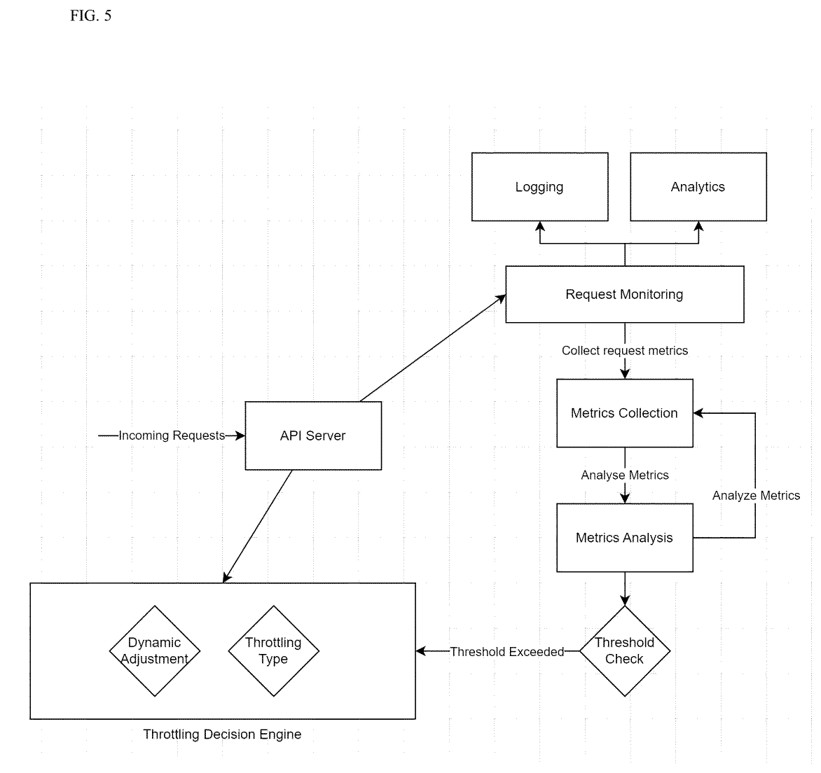

FIG. 5 shows an exemplary throttle injection system to increase system performance and brings substantial advancements to API traffic management. The system uses a throttling decision engine with dynamic adjustment controlled by an API server. The system collects story metrics and analyzes metric data. A threshold check is periodically made and if threshold is above a certain range, the throttling decision engine is used to reduce incoming requests. The throttling decision engine is responsible for managing incoming requests and ensuring optimal API performance. It utilizes dynamic adjustment capabilities that are controlled by the API server itself. The system collects various metrics related to API performance and workload. These metrics can include request rate, server load, response time, and other relevant data points. The system continuously analyzes this metric data to gain insights into the current state of the API and its resource utilization. Periodically, a threshold check is performed to assess the metric values against predefined ranges. If the threshold exceeds a certain range, indicating that the API is approaching its capacity or experiencing performance degradation, the throttling decision engine is triggered. The throttling decision engine makes informed decisions about reducing incoming requests. It takes into account the current API workload, performance metrics, and the desired level of resource allocation. Based on these factors, it applies throttling measures to regulate the rate of incoming requests effectively. The dynamic adjustment capability of the system allows for real-time fine-tuning of throttling parameters. This means that as the workload or performance metrics change, the throttling decision engine can adapt and adjust its strategies accordingly. This flexibility enables the system to effectively handle sudden traffic surges, scale during peak periods, and proactively manage congestion or server load challenges and thus improves computer system performance.

The system can dynamically throttle requests, allowing for adaptive adjustments based on real-time conditions. Unlike traditional systems, it continuously monitors incoming requests and utilizes advanced metrics analysis to make informed decisions on applying throttling measures effectively. An advanced request monitoring system captures detailed API performance and workload data. This serves as the foundation for precise decision-making, ensuring fair resource distribution while mitigating risks associated with server overload and performance degradation. Driving the intelligence of the algorithm is a complex throttling decision engine that incorporates advanced techniques such as data-driven modeling, statistical analysis, and pattern recognition. By evaluating key metrics like request rate, server load, and response time, our algorithm achieves an optimal balance between efficient request processing and maintaining peak API performance. The algorithm also features a dynamic adjustment module, enabling real-time fine-tuning of throttling parameters. This adaptability empowers the system to effectively handle sudden traffic surges, seamlessly scale during peak periods, and proactively manage congestion or server load challenges. The system includes a robust logging and analytics system that captures and analyzes crucial data points, providing deep insights into system performance, usage patterns, and optimization opportunities. This information allows administrators to fine-tune the system, optimize resource allocation, and proactively address emerging challenges. The automatic throttle injection system leverages a sophisticated algorithm that incorporates advanced metrics analysis, dynamic throttling, and adaptive decision-making. It represents a significant advancement in API traffic management, promoting efficient resource utilization, ensuring stable performance, and delivering a superior experience for API providers and clients alike.

By employing the throttling decision engine with dynamic adjustment, the system ensures that the API server can efficiently handle incoming requests while maintaining stable performance. It prevents server overload and mitigates the risks associated with resource exhaustion. Ultimately, this approach helps deliver a superior experience for API consumers by optimizing resource utilization and maintaining consistent API responsiveness. The automatic throttle injection system leverages a sophisticated algorithm that incorporates advanced metrics analysis, dynamic throttling, and adaptive decision-making. The throttling decision system is a significant advancement in API traffic management, promoting efficient resource utilization, ensuring stable performance, and delivering a superior experience for API providers and clients alike.

The application may provide any or all functionality as described herein, which may be separately or in combination, and is not limited only to the specific examples outlined above. The method of cooperatively writing a multi-media story may include any or all functionality outlined above as being provided by the application, which may be separately or in combination, and is not limited only to the specific examples outlined above.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for generating a personalized interactive digital story series, comprising:
receiving user input specifying story preferences and customization options;
retrieving a plurality of story portions, each comprising text, images, audio, or video content, associated with the digital story series;
receiving a user input to determine relevant story portions based on the specified preferences and customization options, wherein a user navigates between story portions, makes choices that influence the narrative, and customizes one or more aspects of the story portions; and
presenting a customized sequence of story portions to the user in an interactive manner.

2. The method of claim 1, further comprising receiving feedback from the user regarding the customized sequence of story portions and incorporating the feedback into one or more iterations of the digital story series.

3. The method of claim 1, wherein the user input specifies preferred genres, themes, or settings for the digital story series.

4. The method of claim 1, wherein the user input specifies preferred character traits, relationships, or roles within the digital story series.

5. The method of claim 1, wherein the user input specifies preferred story elements, such as plot twists, conflicts, or resolutions, to be included in the digital story series.

6. The method of claim 1, wherein the analysis of user input includes comparing the specified preferences and customization options with metadata associated with the story portions, including tags, keywords, or annotations.

7. The method of claim 1, wherein the analysis of user input includes applying machine learning algorithms to identify patterns, similarities, or correlations between user preferences and previous user interactions with the digital story series.

8. The method of claim 1, wherein the customization options allow the user to modify the appearance, personality, or abilities of characters within the story portions.

9. The method of claim 1, wherein the customization options allow the user to choose alternative story branches, paths, or endings within the digital story series.

10. The method of claim 1, wherein the interactive presentation of the customized sequence of story portions includes providing interactive prompts, choices, or puzzles for the user to engage with during the story experience.

11. The method of claim 1, wherein the interactive presentation of the customized sequence of story portions includes multimedia elements, such as animations, sound effects, or voice acting, to enhance the immersion and engagement of the user.

12. The method of claim 1, wherein the user-specific data includes user preferences, customization choices, progress tracking, or saved bookmarks within the digital story series.

13. The method of claim 1, wherein the user-specific data is stored in a cloud-based database accessible across multiple devices, allowing the user to resume the story experience on different platforms.

14. The method of claim 1, wherein the personalized interactive digital story series is generated based on a collaborative effort between multiple authors or contributors.

15. The method of claim 1, further comprising providing a chatbot or virtual assistant within the digital story series, allowing the user to interact with characters or receive guidance and suggestions during the story experience.

16. The method of claim 1, further comprising incorporating real-time data, such as weather conditions, time of day, or location-based information, into the story portions to enhance the relevance and immersion of the user experience.

17. The method of claim 1, wherein the customized sequence of story portions is presented to the user through a mobile application, a web-based platform, a virtual reality environment, or an augmented reality interface.

18. The method of claim 1, wherein the customized sequence of story portions is presented to the user as a continuous narrative or as episodic content.

19. The method of claim 1, further comprising analyzing user engagement metrics, including time spent on each story portion, choices made, or feedback provided, to improve the personalization and overall quality of the digital story series.

20. A method for generating a personalized interactive digital story series, comprising:
receiving user input specifying story preferences and customization options;
retrieving a plurality of story portions, each comprising text, images, audio, or video content, associated with the digital story series;
analyzing the user input to determine relevant story portions based on the specified preferences and customization options;
generating a customized sequence of story portions based on the analysis; and
presenting the customized sequence of story portions to the user in an interactive manner, allowing the user to navigate between story portions, make choices that influence the narrative, and customize aspects of the story portions.
